(19) United States
(12) Patent Application Publication
(10) Pub. No.: US 2026/0291584 A1
(43) Pub. Date: Sep. 24, 2026

(54) RANK STRUCTURE INFORMATION FOR TRANSMISSION WITH PARTICULAR RANK VALUE

(71) Applicant: Nokia Technologies Oy, Espoo (FI)

(72) Inventors: Samantha Caporal Del Barrio, Aalborg (DK); Simon Svendsen; Sami-Jukka Hakola, Kempele (FI); Mihai Enescu, Espoo (FI)

(73) Assignee: Nokia Technologies Oy, Espoo (FI)

(21) Appl. No.: 19/478,580

(22) PCT Filed: Apr. 28, 2023
(86) PCT No.: PCT/EP2023/061299

§ 371 Date: Oct. 24, 2025

(51) Int. Cl. H04B 7/06; H04L 5/00; H04W 24/10; H04W 72/231

(52) U.S. Cl. CPC H04B 7/0626; H04B 7/063; H04L 5/0051; H04W 24/10; H04W 72/231

(57) ABSTRACT

The invention inter alia pertains to a terminal device comprising means for transmitting, to a network node, rank structure information indicative of a particular configuration of one or more reference signal resources useable for channel state information, CSI, acquisition to enable a layered transmission between the network node and the terminal device having a rank value lower than or equal to a particular maximum rank value. The invention also pertains to a network node.

### TECHNOLOGICAL FIELD

The present disclosure is related to but not limited to communication networks as defined by the 3GPP standard, such as the 5G standard, also referred to as New Radio, NR. The disclosure in particular relates to the use of multiple transmission and receiving antennas, i.e. multiple-input and multiple-output, MIMO. More specifically the disclosure pertains to reference signals and the configuration of respective reference signal resources, such as CSI-RS resources. The disclosure further in particular pertains to extended reality devices and their requirements in mobile communication networks.

### BACKGROUND

Devices, such as extended reality devices, employ specific antenna designs, which may for instance be required for spatial restrictions, such as it may be the case in smart glasses, where the antenna elements are integrated into the frame of the glasses. For instance, an implementation for the antenna array mounted in the frame of glasses may present significant advantages in coverage of the azimuth plane as well as lowest human exposure levels. In such a design, the placement of the antenna array is chosen to maximize the coverage while the choice of the antenna elements (for instance four monopoles) is based on minimizing space.

Such a design is different from what is typically employed in smartphones utilizing a patch array design (rather than monopoles as in the above example for the glasses). Such patch array designs allow dual polarized array elements in turn allowing a 2-port-operation on each of the antenna elements. However, in the above example of smart glasses, a patch design would require an increased thickness of the glass frame due to its intrinsic shape and dimensions, which would have a direct impact on the design of the glasses towards bulkier shapes. Therefore, the mentioned monopole design is a significantly more attractive choice although it only allows single-polarized elements, i.e. 1-port-operation on each of the antenna elements. Still, such monopole 1×4 array can support up to 4 ports for the full array.

However, a problem with such single polarization antenna elements is that MIMO operation can only come from having multiple beams simultaneously active for the antenna array in order to decorrelate them, since a decorrelation can no longer be achieved with polarization (or in the polarization domain), which in turn may cause sub-optimal gNB beam management in particular for configuring TCI states for FR2 MIMO.

### SUMMARY OF SOME EXEMPLARY EMBODIMENTS

Considering the exemplary case of a gNB configuration, which is based on polarization diversity, in the above example of a single-polarized array, the resulting transmission may not achieve a rank 2 for 2×2 MIMO. This is because when the network schedules a 2-port CSI-RS where each of the port links to a polarization (e.g. port 1 is sent on H and port 2 is sent on V from the same panel), then, in a line of sight (LOS) scenario, only one port (e.g. port 2 in V-pol) could be detected by a device having vertically polarized antennas.

Thus, a gNB scheduling 2×2 MIMO in the legacy configuration (i.e. an orthogonal polarization from a single panel) would lead to the problem of the UE not being able to detect one of the ports (H in this example), which is a direct waste of scheduling resources for the gNB. Further, the UE would consistently report only rank 1 resulting in unnecessarily limiting the DL throughput, even though rank 2 could actually be supported by the UE.

Thus, certain embodiments of the disclosure may allow the use of higher transmission ranks in downlink than currently supported. Certain embodiments may result in improved downlink throughput. Certain embodiment may provide an improved beam management by the network for configuring TCI states, in particular in for FR2 MIMO.

According to a first exemplary aspect, there is disclosed a terminal device. The terminal device may comprise means for transmitting, to a network node, rank structure information. The rank structure information may be indicative of a particular configuration of one or more reference signal resources useable for channel state information, CSI, acquisition to enable a layered transmission between the network node and the terminal device having a rank value lower than or equal to a particular maximum rank value.

According to a second exemplary aspect, there is also disclosed a network node. The network node may comprise means for receiving, from a terminal device, rank structure information. The rank structure information may be indicative of a particular configuration of one or more reference signal resources useable for channel state information, CSI, acquisition to enable a layered transmission between the network node and the terminal device having a rank value lower than or equal to a particular maximum rank value.

According to each of the exemplary aspects, a respective method is also disclosed.

Thus, according to the first exemplary aspect, there is disclosed a method performed by a terminal device. The method may comprise transmitting, to a network node, rank structure information. The rank structure information may be indicative of a particular configuration of one or more reference signal resources useable for channel state information, CSI, acquisition to enable a layered transmission between the network node and the terminal device having a rank value lower than or equal to a particular maximum rank value.

According to the second exemplary aspect, there is also disclosed a method, performed by a network node. The method may comprise receiving, from a terminal device, rank structure information. The rank structure information may be indicative of a particular configuration of one or more reference signal resources useable for channel state information, CSI, acquisition to enable a layered transmission between the network node and the terminal device having a rank value lower than or equal to a particular maximum rank value.

Any of the disclosed devices (terminal, network node) may generally be a stationary device or a mobile device. The terminal device may in particular be a user equipment (UE), e.g. a mobile device, such as a smartphone, a tablet, a wearable, smart glasses, a smartwatch, a low power device, an IoT device, an IIoT device, a vehicle, a truck, a drone, an airplane, or the like. The terminal device may in particular be an extended reality (XR) device, such as an augmented reality (AR) device, a virtual reality (VR) device or a mixed reality (MR) device. The terminal device may in particular be capable of directly or indirectly communicating with (transmitting and receiving signals and/or data to/from) a network or a network node of a network, such as a base station of a communication network. The network may (at least partially) be a terrestrial network. The network may also be a (partially) non-terrestrial network with one or more non-terrestrial network nodes, for instance a satellite. For instance, the terminal device may in particular be a device configured for MIMO operation. For instance, the network node and/or the terminal device may in particular be configured or comprise one or more antenna elements for operation in frequency range 1 (FR1) and/or frequency range 2 (FR2). FR1 may be understood to cover frequencies from 410 MHz to 7125 MHz. FR2 may be understood to cover frequencies from 24.25 GHz to 71.0 GHz.

Accordingly, a network node may be understood to be a wireless communication station installed at a fixed or mobile location and may in particular be or comprise an entity of the radio access network of the communication system. For instance, the network node may be, comprise, or be part of a base station of a communication network of any generation (e.g. a gNB, eNodeB, NodeB, BTS or the like) of the 3GPP standard. Accordingly, the communication system may in particular be a cellular communication system. In an example of a 5G network, the network node may in particular be or comprise a central unit (CU) or a distributed unit (DU), such as a gNB-CU or gNB-DU. Generally, the network node may be or comprise a hardware or software component implementing a certain functionality. In an example, the network node may be an entity as defined by 3GPP 5G or NR standard (also referred to as gNB). Accordingly, while the network node may be understood to be implemented in or be a single device or module, the network node may also be implemented across or comprise multiple devices or modules. Multiple network nodes of the exemplary aspect may in particular establish a communication system or network, which may in particular be a NR or 5G system (5GS) or part thereof or any other mobile communications system defined by a past or future standard, in particular successors of the present 3GPP standards. A network node of the exemplary first and second aspects may be capable of being in direct and/or indirect communication with the exemplary terminal device of the third aspect.

The means or functionality of any of the disclosed terminal device and network node can be implemented in hardware and/or software. They may comprise one or multiple modules or units providing the respective functionality. They may for instance comprise at least one processor for executing instructions for performing the required functions, at least one memory storing the instructions, or both. Alternatively, they could comprise for instance circuitry that is designed to implement the required functions, for instance implemented in a chipset or a chip, like an integrated circuit. In general, the means may comprise for instance one or more processing means or processors.

Thus, according to the respective exemplary aspects of the present disclosure, there is in each case also disclosed a respective terminal device or network node comprising at least one processor and at least one memory storing instructions that, when executed by the at least one processor, cause the respective apparatus (e.g. the terminal device or the network node) at least to perform a method according to the respective aspect of the present disclosure.

Any of the above-disclosed exemplary aspects may, however, in general be performed by an apparatus, which may be a module or a component for a device, for example a chip. The disclosed apparatus (e.g. the terminal device or the network node) may comprise the disclosed components, for instance means, processor, memory, or may further comprise one or more additional components.

According to the exemplary aspects of the present disclosure, there is in each case also disclosed a computer program, the computer program when executed by a processor of a respective apparatus (e.g. a terminal device or a network node) causing said apparatus to perform a method according to the respective aspect.

The instructions, for instance processor instructions, may be stored on a storage medium that is readable by a processor, in particular a transitory and/or non-transitory medium. The storage medium could for example be a disk or a memory or the like. The storage medium may be intended for taking part in the operation of a device, like an internal or external memory, for instance a Read-Only Memory (ROM) or a hard disk, or be intended for distribution of a program or library including the instructions, like an optical disc.

A configuration of one or more reference signal resources may for instance indicate or define one or more characteristics of the references signal resources to be used. In an example, a configuration may for instance indicate or define one or more characteristics of the ports to be used for these resources. For instance, and as will be described in more detail below, a configuration of a particular reference signal resource may for instance define the number of references signal resources to be used and/or the number of ports to be used for these resources. For instance, a specific configuration may thus define or comprise a specific number of reference signal resources and a specific number of ports for each of the reference signal resources. The one or more reference signal resources may be useable for channel state information, CSI, acquisition. The configuration of one or more reference signal resources may for instance achieve or enable a layered transmission between the network node and the terminal device. The layered transmission may for instance have a particular rank value, such as a rank value lower than or equal to a particular maximum rank value.

The number of reference signal resources of a particular configuration may also determine the number of TCI states that can be simultaneously used/indicated.

A layered transmission may be understood as a transmission where one or multiple transmission layers (or data layers) are allocated to respective antenna ports (e.g. logical or virtual antenna ports) of the device. For instance, the data may be encoded into codewords. For instance, the codewords may then be mapped to respective transmission layers. The transmission layers may then be allocated to respective antenna ports, before being transmitted over the radio channel.

While in the optimal case, the layered transmission may have a rank value equal to a particular maximum rank value, the layered transmission may not necessarily achieve the maximum rank value, so that the rank value may also be lower than the maximum rank value.

Therein, in a physical meaning, a rank may be understood to reflect the number of possible independent paths or parallel communication channels or, in a mathematical sense, it indicates a rank of a channel matrix (or number of linearly-independent column or row vectors in the channel matrix).

In an example, the rank structure information may be indicative of a single particular configuration of one or more reference signal resources. For instance, the terminal device indicates to the network the currently supported or preferred configuration. However, alternatively, the rank structure information may also be indicative of further configurations of one or more reference signal resources and may thus be indicative of at least one particular configuration of one or more reference signal resources. For instance, the terminal device may indicate to the network two or more currently supported or preferred configurations.

Thus, in an exemplary embodiment, the terminal device may report rank structure information to the network node indicative of (at least) a particular configuration, wherein the configuration (or each of them) defines a number of reference signal resources as well as a number of references signal ports (e.g. 1-port or 2-ports RS resource) to use for respective ones of the number of reference signal resources. This enables a layered transmission between the network node and the terminal device having (in the best case) a rank value associated with this configuration. However, the rank value may nevertheless be lower than the particular maximum rank value.

The particular achievable maximum rank or rank value may also be implicitly or explicitly defined by a respective configuration. The achievable maximum rank value may be equal to the sum of all the ports configured for the different reference signal resources of a specific configuration. A respective configuration of reference signal resources may then allow for enabling a layered transmission having a rank value up to this maximum rank value. Furthermore, a configuration indicated by the rank structure information may also pertain to or be applicable for a specific frequency range, for instance frequency range 1, FR1, or frequency range 2, FR2. For example, one or more configurations indicated by the rank structure information may be FR1 configurations. For example, one or more configurations indicated by the rank structure information may be FR2 configurations. For example, one or more configurations indicated by the rank structure information may be both FR1 and FR2 configurations.

A port may be an antenna port, e.g. a physical or logical antenna port. For instance, an antenna port may be associated with specific precoding weights and/or is beamformed in a specific direction.

In an example, the transmission between the terminal device and the network node may be a downlink transmission. In another example, the transmission between the terminal device and the network node may be an uplink transmission.

The rank structure information may for instance indicate different configurations by means of an index, identifier or indicator. For instance, the indication of a configuration by the rank structure information may be realized with an index towards a set or table of multiple configurations. For instance, by transmitting a respective index, one or more generally supported combinations may preliminarily be reported by the terminal device to the network node as part of reporting the capabilities of the terminal device, while a further dynamic reporting of one or more currently supported configurations may follow, as will be explained in more detail below. Alternatively, it is also possible that the transmitted rank structure information may also explicitly define one or more respective configurations therein.

The rank structure information may assist the network node in configuring MIMO transmission while considering the specifics of the respective terminal device or its antenna design. Thus, the terminal device may in particular be a device with a specific antenna design, in particular a limited antenna design compared to a usual smart phone antenna. For instance, the terminal device may (e.g. only) comprise antenna elements, which may allow only a single port per antenna element, i.e. antenna elements allowing only a single polarization (e.g. only vertical or only horizontal polarization). Nevertheless, the terminal device may also be a device with e.g. a patch antenna array supporting polarization in both directions. The terminal device may also comprise or mix antenna elements of different kinds. Since rank structure information is transmitted to the network node, various antenna designs may be supported and be enabled to achieve downlink transmissions having a particular rank value.

As will be explained in more detail below, the rank structure information transmitted by the terminal device may pertain to (at least) a particular configuration currently supported by the terminal device (which may also be referred to as dynamic rank structure information). Such dynamic rank structure information may be transmitted repeatedly or dynamically, as the currently supported or desired configuration(s) may change over time. As will be explained in more detail below, in an example, the terminal device may first transmit (static or semi-static) rank structure capability information pertaining to one or more configurations generally supported by the terminal device (before transmitting the (dynamic) rank structure information indicative of (at least) a currently supported configuration.

Accordingly, in an example, the terminal device may comprise means for determining a particular configuration currently supported by the terminal device, which can then be indicated by the transmitted (dynamic) rank structure information. Such (dynamic) rank structure information may be transmitted in addition to the rank structure capability information, which will be described in more detail below. In contrast to configurations generally supported by the terminal device, the configuration(s) currently supported by the terminal device may be time dependent or dynamic. A configuration currently supported by the terminal device may be understood to be a configuration supported by the terminal device due to the current radio environment or the current channel conditions or a current position/orientation of the terminal device or currently activated/deactivated antenna elements. As already mentioned, the rank structure information may be transmitted by simply indicating respective indices for such currently supported configuration(s), e.g. as part of a dynamic signaling to the network. The rank structure information may be transmitted to the network by lower layer signaling. For instance, the rank structure information may be transmitted via L1 (e.g. via PUCCH) or L2 (e.g. via MAC) signaling. The rank structure information may be transmitted repeatedly or dynamically. For instance, the rank structure information may be transmitted by the terminal device when it is determined that the currently supported configurations change or have changed. Additionally or alternatively, the rank structure information may be transmitted periodically to the network.

The rank structure information may also be referred to as rank construction information, as it may allow to construct a layered transmission between the network node and the terminal device with a particular associated rank value. In other words, the transmission of rank structure information by the terminal device may be considered to be an assisting indication mechanism from the terminal device to the network node. The transmission of rank structure information may be considered as an indication of how to configure the reference signal resources for CSI acquisition to enable a layered transmission having a certain rank between the terminal device and the network node. Thus, based on the transmission of the rank structure information, the terminal device may inform the network node how a respective maximum MIMO transmission ranks can be constructed or built in the downlink or uplink. Accordingly, the rank structure information may also be referred to as rank construction information.

The reported rank structure or construction information can then be used by the network node to select the transmission hypothesis for the configuration of the reference signals, for instance for the configuration of the various reference signals used for CSI acquisition.

In an example, the particular configuration of the rank structure information is indicative of a number of reference signal resources. For instance, a configuration may indicate one reference signal resource. For instance, a configuration may define two reference signal resources. For instance, a configuration may define three reference signal resources. For instance, a configuration may define four reference signal resources.

Additionally or alternatively, the particular configuration of the rank structure information may be indicative of a number of ports to be used for a respective reference signal resource of the particular configuration. For instance, a configuration may define one port for each of the reference signal resources of a configuration. For instance, a configuration may define two ports for each of the reference signal resources of a configuration. For instance, a configuration may define either one port or two ports for each of the reference signal resources of a configuration.

In an example, the particular maximum rank value is equal to a total number of ports (to be used for respective reference signal resources) summed across the number of reference signal resources (indicated by the particular configuration).

In an example, the reference signal resources are channel state information reference signal, CSI-RS, resources. The CSI-RS resources are used for a reference signal transmitted by the network node to the terminal device in order to estimate the downlink radio channel (and also the uplink radio channel in case of channel reciprocity, e.g. in TDD deployments). The terminal device will estimate the downlink radio channel based on the received reference signals, and transmit a corresponding report to the network node.

In an example, the reference signal resources are sounding reference signal, SRS, resources. The SRS resources are used for a reference signal transmitted by the terminal device to the network node in order to estimate the uplink radio channel (and also the downlink radio channel in case of channel reciprocity, e.g. in TDD deployments). The network node will estimate the uplink radio channel based on the received reference signals.

In an example, the particular configuration is determined based on a current radio environment of the terminal device. More specifically, the particular configuration is determined based on current channel conditions as observed by the terminal device. Additionally or alternatively, the particular configuration is determined based on a position and/or orientation of the terminal device. For instance, the particular configuration is determined based on activated and/or deactivated antenna elements (or activation/deactivation status of antenna elements) of the terminal device.

In an example, the terminal device may comprise means for transmitting, to the network node, rank structure capability information indicative of one or more configurations of reference signal resources supported by the terminal device and associated with respective supported maximum rank values. Accordingly, the network node may comprise means for receiving, from the terminal device, rank structure capability information indicative of one or more configurations of reference signal resources supported by the terminal device and associated with respective supported maximum rank values. A configuration supported by the terminal device may be understood as a configuration generally supported or supported time independently (static or semi-static information). A configuration supported by the terminal device may be understood to be a configuration supported by the terminal device due to its capabilities, in particular irrespective of any current factors, such as the current radio environment or the current channel conditions or a current position/orientation of the terminal device or currently activated/deactivated antenna elements. The rank structure capability information may be transmitted as already described for the rank structure information, e.g. by simply indicating respective indices for such generally supported configurations, e.g. as part of reporting the capabilities of the terminal device to the network. Alternatively, it is also possible that the transmitted rank structure capability information may also explicitly define one or more respective configurations therein. The rank structure capability information may be transmitted to the network by higher layer signaling. For instance, the rank structure capability information may be transmitted via RRC signaling.

As already explained for the rank structure information, a respective configuration of the one or more configurations may be indicative of a number of reference signal resources and/or a number of ports to be used for a respective reference signal resource. Also, as already explained for the rank structure information, a respective supported maximum rank value associated with the respective configuration (of the rank structure capability information) may be equal to a total number of ports summed across the number of reference signal resources.

In an example, the rank structure capability information (or the determining thereof) is based on a number of antenna elements of the terminal device (e.g. irrespective of whether they are presently activated or deactivated). In an example, the rank structure capability information (or the determining thereof) is based on a capability or (physical) characteristic of one or more antenna elements of the terminal device. For instance, the rank structure capability information (or the determining thereof) is based on a physical structure of one or more antenna elements (e.g. whether the antenna elements are monopole or patch antennas). For instance, the rank structure capability information (or the determining thereof) is based on an arrangement (or placement) of one or more antenna elements of the terminal device. For instance, the rank structure capability information (or the determining thereof) is based on a polarization mode supported by one or more antenna elements of the terminal device. For instance, the rank structure capability information (or the determining thereof) is based on a number of physical antenna ports of one or more antenna elements of the terminal device, for instance 1-port or 2-ports antenna elements.

In an example, the terminal device comprises means for using a default configuration indicated by the terminal device in the rank structure capability information. Likewise, the network node may comprise means for using a default configuration of the rank structure capability information, in particular before transmitting to the terminal device or receiving from the terminal device rank structure information indicating a suitable reference signal configuration useable for channel state information, CSI, acquisition. For instance, as long as the terminal device has not yet determined or transmitted a currently supported reference signal configuration (i.e. the rank structure information), the terminal device and the network may assume a default reference signal configuration (and thus a default reference signal resource and port configuration), which may for instance be the first indicated reference signal configuration (e.g. with the lowest index) in the rank structure capability information. This reference signal configuration may e.g. be used for reference signal transmission configurations as long as the terminal device has not yet reported one or more particular (currently supported) configurations.

In an example, the particular configuration of the rank structure information is selected from the one or more configurations of the rank structure capability information. For instance, the terminal device may comprise means for selecting a particular configuration from the one or more configurations of the rank structure capability information. Accordingly, in an example, the one or more configurations indicated by the rank structure information are a subset of the one or more configurations indicated by the rank structure capability information.

In an example, the terminal device comprises means for receiving, from the network node, a request for (dynamically) transmitting the rank structure information. Accordingly, the network node may comprise means for transmitting, to the terminal device, a request for (dynamically) transmitting the rank structure information. The terminal device may receive a reporting configuration (e.g. via higher layer signaling, such as RRC signaling) for a dynamic reporting (periodic, semi-periodic, or aperiodic reporting) of the rank structure information, e.g. via lower layer signaling, e.g. via PUCCH or MAC signaling. For instance, the reporting configuration may schedule uplink resources for a dynamic reporting of the rank structure information indicating (a least) a particular and currently supported reference signal configuration to the network.

As already mentioned, the layered transmission may be a downlink transmission or an uplink transmission.

In an example for the downlink case, the layered transmission is a downlink layered transmission from the network node to the terminal device, and the one or more reference signal resources are one or more channel state information reference signal, CSI-RS, resources. Further, the network node further comprises means for transmitting, to the terminal device, a reference signal configuration and a reference signal measurement configuration, wherein the reference signal configuration is determined in accordance with the particular configuration. Accordingly, the terminal device may comprise means for receiving, from the network node, a reference signal configuration and a reference signal measurement configuration, wherein the reference signal configuration is determined in accordance with the particular configuration. For instance, in case the particular configuration indicates a certain number of reference signal resources and/or a certain number of ports to be used for a respective reference signal resource, the reference signal configuration provides the terminal device with a corresponding configuration according to the certain number of reference signal resources and the certain number of ports to be used for a respective reference signal resource. For instance, the reference signal measurement configuration (e.g. DL TCI state) may provide information to the terminal device for measuring one or more configured reference signals. For instance, while the reference signal configuration and the reference signal measurement configuration as such may be provided by RRC signaling (e.g. utilizing RRC IEs such as CSI-ResourceConfig, NZP-CSI-RS-ResourceSet, NZP-CSI-RS-Resource or CSI-MeasConfig, CSI-ReportConfig), the reference signal resource and the measurement reports may then be activated or triggered by MAC signaling (e.g. for semi-persistent scheduling) or DCI signaling (e.g. for aperiodic scheduling).

In an example, the network node may comprise means for transmitting, to the terminal device, based on the reference signal configuration, one or more configured reference signals (e.g. CSI-RS). Accordingly, in an example, the terminal device may comprise means for measuring, based on the reference signal configuration and on the reference signal measurement configuration, one or more configured reference signals (e.g. CSI-RS).

In an example, the terminal device may comprise means for transmitting, to the network node, a measurement report (e.g. a CSI report) on the one or more configured reference signals. Accordingly, in an example, the network node may comprise means for receiving, from the terminal device, a measurement report (e.g. a CSI report) on the one or more configured reference signals.

In an example, the network node may comprise means for transmitting, to the terminal device, downlink control information scheduling the layered transmission (and consequently a corresponding downlink transmission). Accordingly, in an example, the terminal device may comprise means for receiving, from the network node, downlink control information scheduling the layered transmission (and consequently a corresponding layered downlink transmission). The downlink transmission may for instance be a shared channel transmission, e.g. a DL PDSCH transmission. The downlink transmission may be a MIMO transmission. The downlink transmission may be layered downlink transmission. The downlink transmission may achieve the rank value of the rank structure information, or a lower rank value. The downlink control information may be based on the measurement report received from the terminal device.

In an example for the uplink case, the layered transmission is an uplink layered transmission from the terminal device to the network node, and the one or more reference signal resources are one or more sounding reference signal, SRS, resources. The network node may for instance comprise means for transmitting, to the terminal device, a reference signal configuration (e.g. UL TCI state, SRI, spatial relation information or cri-RSRP-Capability [Set] Index), wherein the reference signal configuration is determined in accordance with the particular configuration. Accordingly, the terminal device may further comprise means for receiving, from the network node, a reference signal configuration, wherein the reference signal configuration is determined in accordance with the particular configuration. For instance, while the reference signal configuration as such may be provided by RRC signaling (e.g. utilizing RRC IEs such as SRS-Config, SRS-ResourceSet, SRS-Resource), the reference signal resource may then be activated or triggered by MAC signaling (e.g. for semi-persistent scheduling) or DCI signaling (e.g. for aperiodic scheduling).

In an example, the terminal device may further comprise means for transmitting, to the network node, and based on the reference signal configuration, one or more configured reference signals. Accordingly, in an example, the network node may comprise means for receiving, from the terminal device, and based on the reference signal configuration, one or more configured reference signals.

Consequently, in an example, the network node may comprise means for transmitting, to the terminal device, downlink control information scheduling the layered transmission (and consequently a corresponding uplink transmission). Accordingly, in an example, the terminal device may comprise means for receiving, from the network node, downlink control information scheduling the layered transmission (and consequently a corresponding uplink transmission). The uplink transmission may for instance be a shared channel transmission, e.g. a UL PUSCH transmission. The uplink transmission may be a MIMO transmission. The uplink transmission may be layered uplink transmission. The uplink transmission may achieve the rank value of the rank structure information, or a lower rank value. The downlink control information may be determined by the network node based on measurements on the one or more configured reference signals transmitted by the terminal device.

In an example, the particular configuration indicated by the rank structure information is selected from a set (e.g. a table) comprising one or more of the following configurations.

For instance, the set may comprise a configuration pertaining to rank 2 and defining one reference signal resource with two ports. For instance, the set may comprise a configuration pertaining to rank 3 and defining one reference signal resource with three ports. For instance, the set may comprise a configuration pertaining to rank 4 and defining one reference signal resource with four ports. The above configuration may for instance be FR1 configurations.

For instance, the set may comprise a configuration pertaining to rank 2 and defining one reference signal resource with two ports. For instance, the set may comprise a configuration pertaining to rank 2 and defining two reference signal resources with one port each. For instance, the set may comprise a configuration pertaining to rank 3 and defining two reference signal resources with one port and two ports, respectively. For instance, the set may comprise a configuration pertaining to rank 3 and defining three reference signal resources with one port each. For instance, the set may comprise a configuration pertaining to rank 4 and defining two reference signal resources with two ports each. For instance, the set may comprise a configuration pertaining to rank 4 and defining four reference signal resources with one port each. The above configuration may for instance be FR2 configurations.

The set or table with respective configurations may be predefined. The terminal device and the network may only need to transmit a corresponding index of a certain configuration in order to report that a certain configuration is (generally or currently) supported for constructing a certain rank in a downlink transmission.

It is to be understood that the presentation of the embodiments disclosed herein is merely by way of examples and non-limiting.

Herein, the disclosure of a method step shall also be considered as a disclosure of means for performing the respective method step. Likewise, the disclosure of means for performing a method step shall also be considered as a disclosure of the method step itself.

Other features of the present disclosure will become apparent from the following detailed description considered in conjunction with the accompanying drawings. It is to be understood, however, that the drawings are designed solely for purposes of illustration and not as a definition of the limits of the present disclosure, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 shows a schematic diagram illustrating an example radio environment in which exemplary embodiments of the present disclosure may be performed;

FIGS. 2a, b, c shows an antenna placement and design in XR glasses and the resulting radiation pattern;

FIG. 3a, b, c exemplarily illustrates the problem underlying the present disclosure (FIG. 3a, b) and an exemplary embodiment of the present disclosure addressing this problem (FIG. 3c);

FIG. 4a, b illustrates two signaling charts of exemplary embodiments of the present disclosure;

FIG. 5a, b illustrates how the channel environment may affect the rank detected by a single-polarized array at the UE;

FIG. 6 shows a schematic diagram illustrating a block diagram of an exemplary embodiment of a terminal device according to the present disclosure;

FIG. 7 shows a block diagram of an exemplary embodiment of a network node; and

FIG. 8 shows a schematic illustration of examples of tangible and non-transitory computer-readable storage media.

### DETAILED DESCRIPTION OF THE FIGURES

The following description serves to deepen the understanding of the present disclosure and shall be understood to complement and be read together with the description of example embodiments of the present disclosure as provided in the above SUMMARY section of this specification.

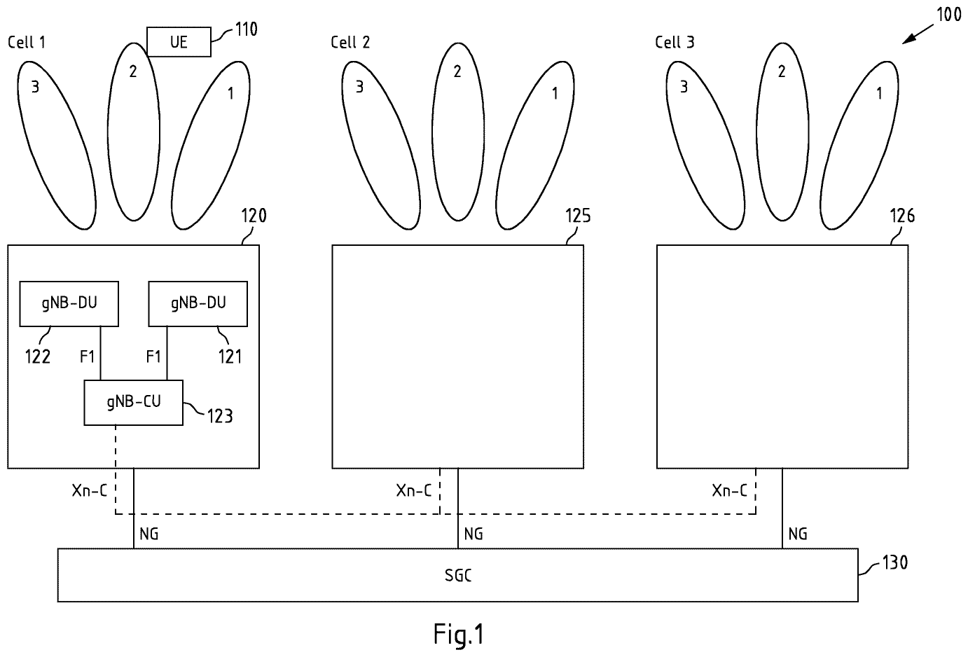

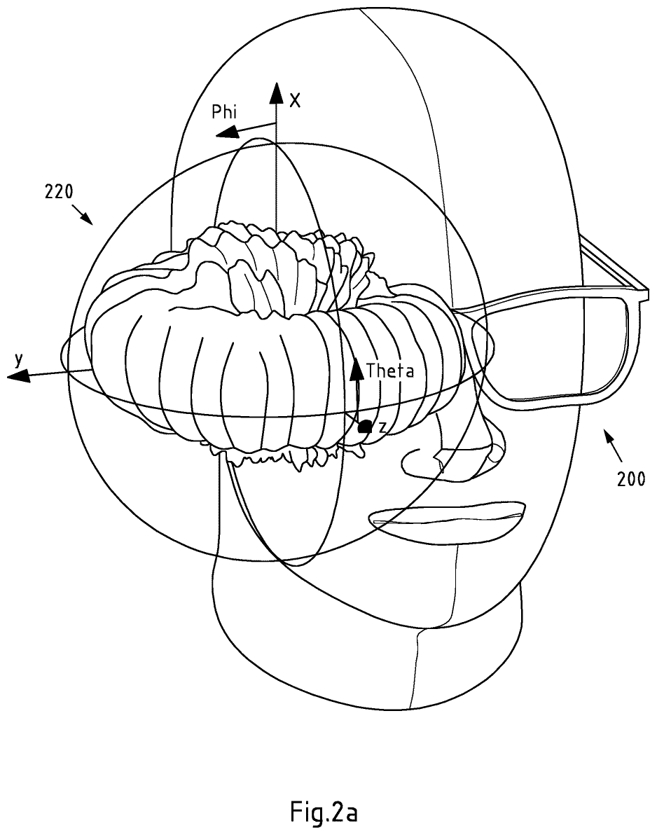

In connection with FIG. 1, an example communication system, in which the present disclosure may be applied, is first described. While the specific radio system in the examples below is a 5G system, this is only to be considered a non-limiting example, and the invention may likewise be employed in past or future generation mobile communication systems or communication systems of a different standardization.

FIG. 1 shows a 5G communication network 100, which employs the New Radio (NR) technology and also an architecture for which the different sublayers of the RAN may be split into two logical entities in a communication network control element (like a BS or gNB), which are referred to as distributed unit (DU, as an example of a network node according to the present disclosure) and central unit (CU, as a further example of a network node according to the present disclosure). For example, the CU is a logical node that controls the operation of one or more DUs over a front-haul interface (referred to as F1 interface). The DU is a logical node including a subset of the gNB functions, depending on the functional split option. For instance, the layer 1 and layer 2 protocols may be implemented in the DU, while the layer 3 protocols may be implemented in the CU.

As shown in FIG. 1, a first user equipment (UE) 110, as an example of a terminal device of the exemplary aspects of the present disclosure, is connected to a cell 1 of a network node or base station, a gNB 120 via a communication beam of the cell 1. In the example shown in FIG. 1, the gNB 120 is provided with a CU 123 and two DUs 121 and 122 being connected to the CU 123 by a F1 interface. Cell 1 may be considered to be a serving cell or source cell for the UE 110. Furthermore, as shown in the example of FIG. 1, there is a plurality of further cells to which the first UE 110 can connect. Similarly to cell 1, cells 2 and 3 are controlled by gNBs 125 and 126, respectively. Each gNB may provide a plurality of beams 1 to 3, which may be used for beamforming. As shown in FIG. 1, each base station or gNB of the cells is connected to a core network 130, such as a 5GC, via respective interfaces, indicated as NG interfaces. Furthermore, each gNB of the cells is connected with each other by means of a specific interface, which is referred to e.g. as an Xn-C interface. Any of these network entities, such as the gNB, gNB-DU, gNB-CU and/or 5GC, may individually or together be an example of a network node according to the present disclosure.

The UE 110 and the network (i.e. gNB, gNB-DU, gNB-CU and/or 5GC) may exchange rank structure information and rank structure capability information as described herein.

An exemplary use case for the present disclosure is the use case of extended reality (XR), which may illustrate the advantages of the present disclosure. The term Extended reality is an umbrella for the following 3 types of reality:
Augmented Reality (AR): adding virtual objects to real-world environments. Typical devices may be tablets or glasses.
Virtual Reality (VR): visual and audio scene combined with real-world locations. Typical devices may be Head Mounted Displays (HMDs).
Mixed Reality (MR): adding haptics and interactions. Typical devices may be glasses or controllers.

Extended reality requires various different technical requirements regarding the devices and their capabilities, for instance XR may require:
glasses and HMDs with various cameras (environment and eye tracking) and sensors;
precise and fast positioning of 6DoF (~1 cm and) 1°, bandwidth massive downlink and uplink capacity for splitting the chip;
low latency to enable an immersive experience;
edge computing for offloading tasks from the device;
mapping for supporting the pose estimation, the digital twin, and needed for occlusions;
digital twin for efficient provisioning of content; and/or security & privacy requirements as several cameras are integrated into XR devices and a huge amount of privacy affecting data is stored.

Therefore, the following objectives may be defined:
confirm XR and Cloud Gaming applications of interest;
identify the traffic model for each application of interest taking outcome of SA WG4 work as input, including considering different upper layer assumptions, e.g. rendering latency, codec compression capability etc.;
identify evaluation methodology to assess XR and Configured Grant, CG, performance along with identification of Key Performance Indicators, KPIs, of interest for relevant deployment scenarios;
once traffic model and evaluation methodologies are agreed, carry out performance evaluations towards characterization of identified KPIs.

For XR coverage, it is observed that for deployment scenarios of dense urban and urban macro, UL coverage is worse than DL coverage. Regarding the performance of mobility for AR, VR, and CG applications, there are two mobility KPIs, namely number of consecutive XR packets lost due to a handover event and minimum target time between handover events. The evaluation methodology of mobility performance is a simplified analytical approach. The following can be observed:
Higher Packet Delay Budget, PDB, leads to lower (better) mobility KPIs.
Higher frame rate leads to higher (worse) number of consecutive XR packets lost.
When varying the handover interruption time, the lower (better) mobility KPIs are achieved when handover interruption time is lower than PDB.
Higher handover interruption time leads to higher (worse) mobility KPIs.

Many XR use cases are DL-heavy, e.g. for VR and GC, we have high-resolution video in DL (30-45 Mbps per UE), while UL is just 100 bits/s per UE. As such, for the default TDD configuration agreed for the XR SI, (DDDSU), the system is also DL-limited in terms of capacity: 3-7 XR UEs supported in DL vs 40+ UEs in uplink, if only XR UEs are present. Furthermore, the beam management is downlink based; meaning that some DL slots are reserved for DL Reference Signals (RS) for beam alignment, beam tracking, etc. of both gNB and UE. Therefore, the DL capacity is further limited due to fewer occasions to schedule data in order to ensure beam alignment.

There are therefore the following objectives on XR-specific capacity improvements (RAN1, RAN2):
Study mechanisms that provide more efficient resource allocation and scheduling for XR service characteristics (periodicity, multiple flows, jitter, latency, reliability, etc . . . ). Focus is on the following mechanisms:
   SPS and CG enhancements;
   Dynamic scheduling/grant enhancements.

Accordingly, it can be understood that there is the need for different types of devices including XR smart glasses antennas to enhance the capacity. This requirement is particularly relevant for MIMO transmission in FR2.

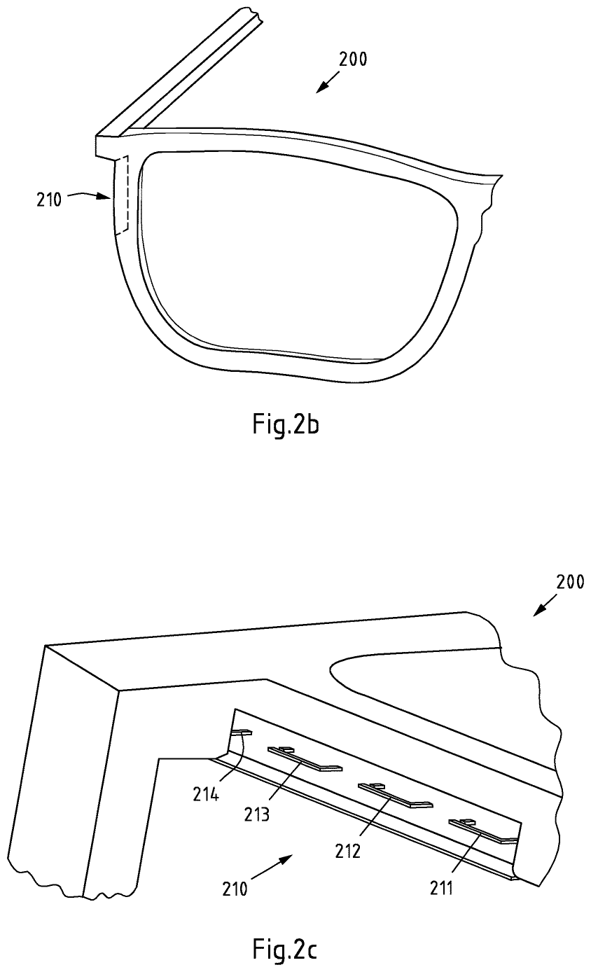

In order to further illustrate the problem underlying the present disclosure, it is referred to FIG. 2 showing an implementation for an exemplary antenna array 210 mounted on glasses 200. The implemented antenna array 210 can present significant advantages in coverage of the azimuth plane as well as lowest human exposure levels, as illustrated by the radiation pattern 220 in FIG. 2a. In this design, the placement of the antenna array 210 is chosen to maximize the coverage while the choice of antenna elements 211, 212, 213, 214 (four monopoles) is based on minimizing space.

Typically on smartphones, a patch array design is chosen (rather than monopoles as shown here for the glasses) in order to have dual polarized array elements i.e. for 2-port-operation on each of the antenna elements. However, on smart glasses, a patch design would require an increased thickness of the glass frame due to its intrinsic shape and dimensions, which would have a direct impact on the design of the glasses towards bulkier shapes. Therefore, a monopole design (as shown in FIG. 2) is a significantly more attractive choice although it contains only single-polarized antenna elements, i.e. 1-port-operation on each of the antenna elements. Such monopole 1×4 array can support up to 4 ports for the full array.

The problem with single polarization antenna elements is that MIMO operation can only come from having multiple beams simultaneously active on the smart glasses array in order to decorrelate them since decorrelation can no longer be achieved with polarization (or in the polarization domain). This is not indicated to the network which may cause sub-optimal gNB beam management for configuring TCI states for FR2 MIMO.

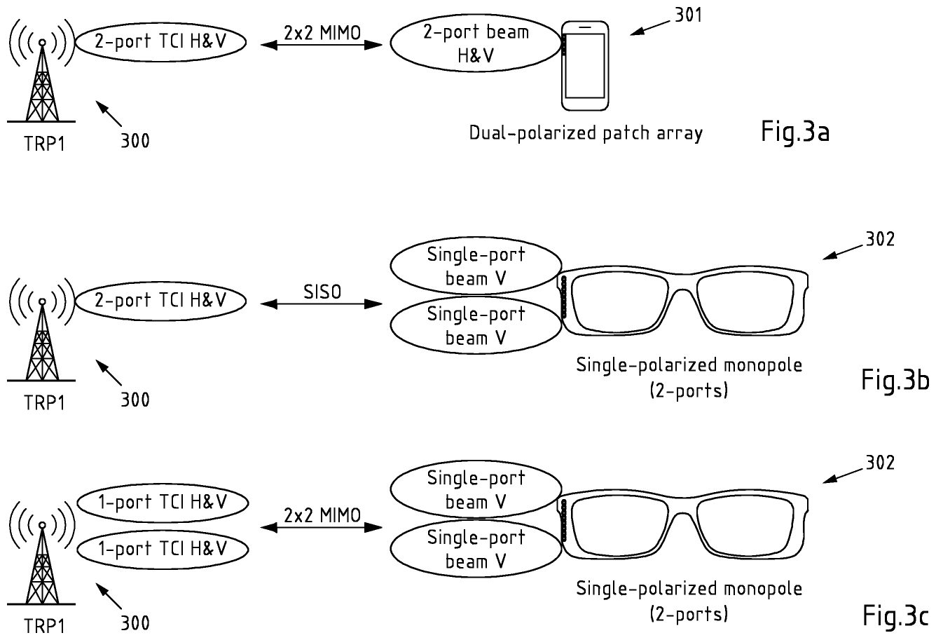

The problem is further exemplarily illustrated in FIG. 3 for a Line of Sight (LoS) scenario, showing that setting up MIMO on XR glasses may require 2 TCI states and trying this from a 2-port single beam may just be a waste of resources for the network and may unnecessarily limit the transmission to rank 1.

FIG. 3a shows a gNB 300 with typical 2-port TCI state configuration (co- and cross-polarization e.g. H-pol and V-pol) and a UE 301 with single 2-port beam configuration (dual-polarized patches with H-pol and V-pol) which can support 2×2 MIMO.

FIG. 3b shows that the same gNB configuration, based on polarization diversity, of gNB 300 might not lead to rank 2 for 2×2 MIMO for a LOS scenario if the device 302 is instead using a single-polarized array (e.g. 1×4 monopole array, as for the smart glasses as shown in FIG. 2). However, such a smart glasses UE 302 could use its mmW panel as two sub-array beams, each of the beams being single-port and single-polarized (e.g. V-pol) i.e. use two different monopole panels, one panel located at the vertical frame at each lens. Therefore, when the gNB 300 schedules a 2-port CSI-RS where each of the port links to a polarization (e.g. port 1 is sent on H and port 2 is sent on V from the same panel), then in LoS only port 2 in V-pol can be detected by the device.

The clear problems illustrated by FIG. 3b for the gNB scheduling 2×2 MIMO in legacy configuration (orthogonal polarization from a single panel) are as follows:
1. When one port (H in this example) cannot be detected by the UE, this is a direct waste of scheduling resources for the gNB.
2. The smart glasses UE will consistently report rank 1 resulting in unnecessarily limiting DL throughput.
3. Rank 2 could be supported but cannot be found.

FIG. 3c, however, shows that 2×2 MIMO could in fact be supported, if only the gNB 300 had received assistance from UE to know how to configure TCI states for such a smart glasses UE 302 with multi-port single-polarized array design. Indeed, if the gNB 300 configures 2 TCI states each of them from different sub-panels then decorrelation may be achieved within the spatial or space domain on gNB 300 and/or UE 302 and 2×2 MIMO may be supported. However, this behavior from the gNB 300 is currently not indicated by the UE 301/302. Note that FIG. 3c is valid for collocated or non-collocated TRPs.

It is noted that simply reporting the number of ports per UE panel is not sufficiently indicating to gNB the required TCI state configuration to obtain MIMO. This illustrated problem is valid for downlink and uplink.

The present disclosure therefore goes beyond simply reporting the number of ports, as this may not solve the presented issue, since the UE may have multiple ports but no single antenna element can support more than a single port. The present disclosure moves beyond the idea of the UE having a static maximum transmission rank configuration so that for instance the CSI-RS resource configuration for the CSI acquisition is also having at maximum as many antenna ports as the UE specific maximum rank. The present disclosure also addresses the issue of only having a single CSI-RS resource used for CSI acquisition to “construct the rank” e.g. in FR1.

The present disclosure therefore suggests an indication mechanism of a rank structure construction at the receiver between a terminal device (in the following also referred to as UE) and the network or network node (in the following also referred to as gNB) based on which the UE can inform the network how particular (i.e. high) MIMO transmission ranks can be built in a downlink or uplink transmission.

For instance, the structure could be corresponding to a CSI-RS resource configuration needed to build a certain rank. While the following examples may refer to CSI-RS and CSI resources, this may only be understood as an example and the embodiments may be understood to not be limited to these use cases and they also apply for instance to other resources and reference signals.

For instance, there may be certain pre-defined options from which the UE may select one (or more) supported ones from the options for FR1 or FR2 exemplarily provided below. For this, the UE may report rank structure information to the network indicative of respective resources and ports.

For instance, the pre-defined options or configurations may comprise FR1 use cases with single CSI-RS resource. Accordingly, the set or table of configurations may comprise one or more pre-defined options for FR1 configurations from which the UE may select one or more supported options.

For instance, there may be one configuration (e.g. Option 1) for rank 2, defining that the UE needs one CSI-RS resource. For instance, there may be one configuration (e.g. Option 2) for rank 3, defining that the UE needs one CSI-RS resource. For instance, there may be one configuration (e.g. Option 3) for rank 4, defining that the UE needs one CSI-RS resource. For instance, each of the above options 1-3 could correspond to operation in FR1 since the UE antennas at FR1 typically have different spatial, space and polarization properties for different angular directions.

There may be multiple FR2 use cases with multiple combined CSI-RS resources. Accordingly, the set of configurations may comprise one or more pre-defined options for FR2 configurations from which the UE may select one or more supported options.

For instance, there may be one configuration (e.g. Option 4) for rank 2, defining that the UE needs one CSI-RS resource. For instance, this could correspond to a UE with dual-polarized elements in the antenna panel/array. For instance, there may be one configuration (Option 5) for rank 2, defining that the UE needs two combined CSI-RS resources. This could correspond to single-polarized antenna elements in the panel/array of the terminal device. For instance, there may be one configuration (Option 6) for rank 3, defining that the UE needs two combined CSI-RS resources. This could correspond to one dual-polarized antenna panel and one single-polarized antenna panel operation. For instance, there may be one configuration (Option 7) for rank 3, defining that the UE needs three combined CSI-RS resources. For instance, this corresponds to three single-polarized antenna panels. For instance, there may be one configuration (Option 8) for rank 4, defining that the UE needs two combined CSI-RS resources. This could correspond to UE architecture with two panels having dual-polarized elements. For instance, there may be one configuration (Option 9) for rank 4, defining that the UE needs four combined CSI-RS resources. This could correspond to four single-polarized antenna elements.

Based on the described UE indication of a rank structure construction at the receiver, the gNB is able to configure properly the CSI-RS resource(s) for the CSI acquisition as well as for beam reporting (in order to find out multiple parallel beams). The indication signaling from the UE can be dynamic in order to be able to react to e.g. UE rotations in case the UE is equipped with antennas/panels with different characteristics (different number of ports, different number of polarization dimensions).

In example embodiments, the UE will report rank structure information to the network by first transmitting to the network rank construction capability information or rank construction options and then transmitting to the network rank structure information for a dynamic indication of which option(s) can currently be supported. That is, more specifically, the UE may for instance perform a capability signaling of which options are possible for the UE (e.g. a UE indication based on the physical placement and characteristics of its array(s)). The UE may then perform a dynamic indication of which option(s) can currently be supported, which can be considered a mechanism that facilitates the UE to inform how certain MIMO ranks can be constructed at a specific time instance from the UE panel/antenna availability point of view and e.g. depending on channel characteristics, UE position/orientation towards network nodes, number of activate/deactivated antenna elements.

The advantages of these approaches are that the network will be able to properly configure and trigger for instance CSI-RS resources for the CSI acquisition and exploit properly the antenna conditions at the UE at a given time.

Put differently, the disclosure introduces an approach to build the transmission rank in different ways in terms of e.g. CSI-RS resources by taking into account different types and characteristics of the UE antennas that are feasible at a time (e.g. in FR2 typically a subset of antennas/antenna panels are usable at a time due to beam based operation).

More specifically, the disclosure provides a new level of detail differentiating between the different ways to support different transmission ranks. Therein, the UE may indicate which one(s) of these configurations can be supported from its physical structure (e.g. number, placement and characteristics of the FR2 panels) as a capability and/or which one(s) of the supported options can be activated depending on dynamic channel characteristics, UE orientation etc.

In the following, an exemplary set or table of different configurations, which may be indicated by rank structure information is given. However, depending on the needs only parts of the table may be used and/or additional options may be added. The set or table may be pre-defined by the specification. Alternatively, the table may be generated by the network or the UE and then used for further signaling. The exemplary index numbers in the below table correspond to the use cases already described above as option 1-9.

| Index of rank | Max | CSI-resources | Number | Use |
|---|---|---|---|---|
| structure | Rank | needed | of ports | Case |
| 1 | 2 | One CSI-RS resource | 2 | FR1 |
| 2 | 3 | One CSI-RS resource | 3 | |
| 3 | 4 | One CSI-RS resource | 4 | |
| 4 | 2 | One CSI-RS resource | 2 | FR2 |
| 5 | 2 | Two combined CSI-RS resources | 1 + 1 | |
| 6 | 3 | Two combined CSI-RS resources, one | 1 + 2 | |
| | | with two ports and one with one port. | | |
| 7 | 3 | Three combined CSI-RS resources | 1 + 1 + 1 | |
| 8 | 4 | Two combined CSI-RS resources | 2 + 2 | |
| 9 | 4 | Four combined CSI-RS resources | 1 + 1 + 1 + 1 | |

However, it shall be noted that the index numbering and the configurations provided above are only exemplary. Different index numbers, a different ordering, only a part of the above configurations, and/or additional configurations may be used.

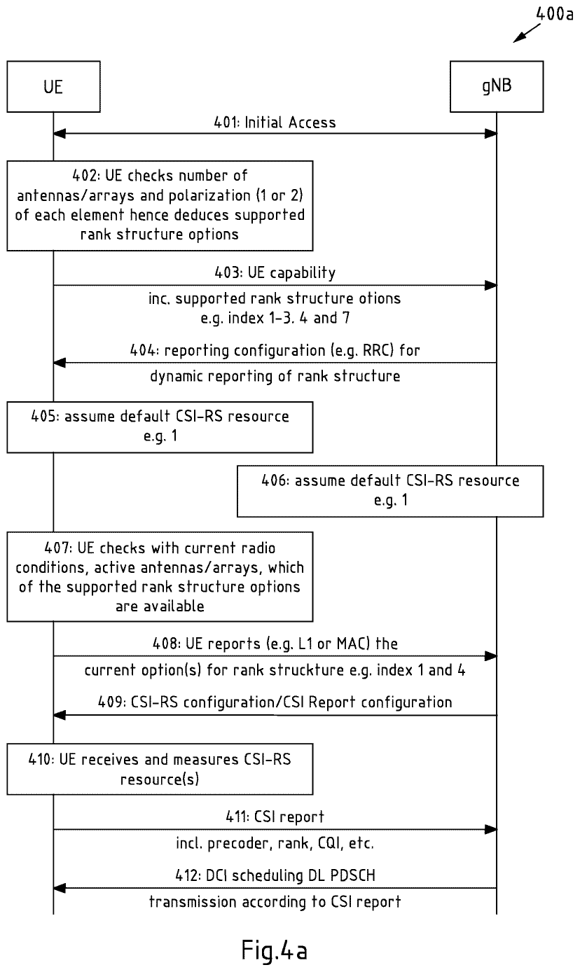

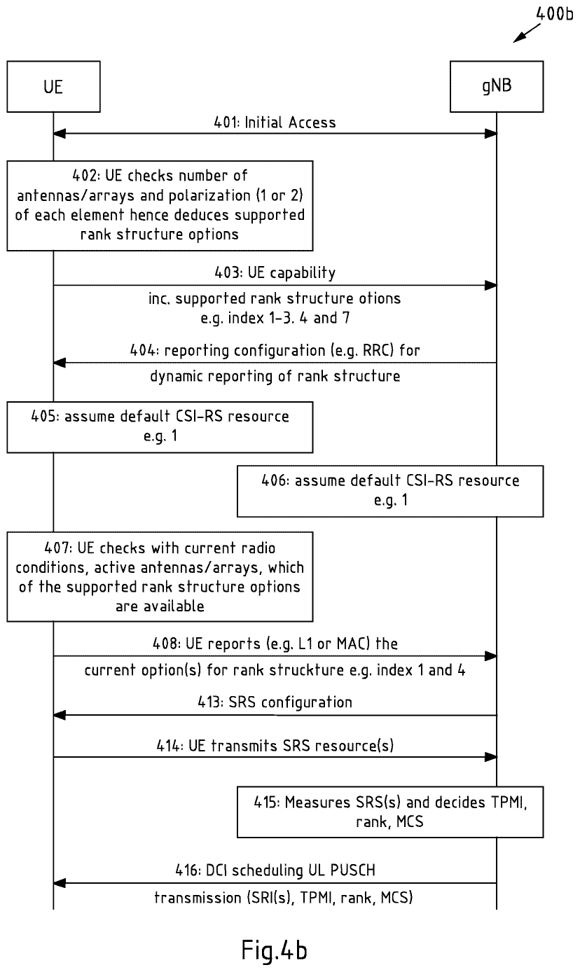

Two example embodiments will now be described with reference to FIGS. 4a and 4b showing two signaling flow charts 400a, 400b illustrating the different aspects of the disclosure.

First, referring to FIG. 4a, the approach described herein is employed for CSI-RS and a downlink transmission. After a connection has been established between the UE and gNB (e.g. by mean of a Random Access procedure or the like), action 401, the UE may determine rank structure capability information indicative of one or more configurations of reference signal resources supported by the UE and associated with respective supported maximum rank values. More specifically the UE may inter alia check the number of antennas/arrays and the polarization (e.g. 1 or 2) of each element and may then deduce the generally supported one or more configurations for the rank structure, action 402. Alternatively, the UE may also have this information stored or otherwise readily available.

The UE then provides as part of a capability report or capability information the identified configuration(s) or option(s) of the rank structure the UE can generally support during the connected state, action 403. In this case the indices 1-3, 4 and 7 are reported. This rank structure information may be transmitted (e.g. via RRC) by only transmitting corresponding indices of a predefined table of configurations. In this way, the UE can efficiently transmit, to the network, rank structure capability information indicative of one or more configurations of reference signal resources generally supported by the terminal device and associated with respective supported maximum rank values.

The UE then receives (e.g. via RRC) a reporting configuration for transmitting or dynamically reporting rank structure information of currently supported rank structure option(s), action 404.

Both, the UE and the gNB may assume a default option for the CSI-RS configuration, actions 405, 406, before the first transmission of rank structure information indicative of a particular configuration from the UE. For instance, the default option may be the first option, i.e. in this case the single CSI-RS resource may be the default option and may be assumed to be the first option until the UE dynamically reports the preferred option (e.g. via L1 or MAC reporting), see action 408, and the gNB indicates the CSI configuration, see action 409.

The UE may then determine rank structure information indicative of one or more particular configurations currently supported or preferred by the UE. That is the UE may determine rank structure information indicative of a particular configuration of one or more reference signal resources useable for channel state information, CSI, acquisition to enable a layered transmission between the network and the UE having a rank value lower than or equal to a particular maximum rank value. For instance, the UE may inter alia check the current radio conditions, the active antennas/arrays, and eventually determine which of the generally supported and previously reported rank structure configuration (see action 403) are also currently available, action 407.

The UE then transmits rank structure information to the network by dynamically reporting, to the gNB, those configuration(s) or option(s) for constructing the rank (among the options indicated previously in capability, see action 403) supported also currently e.g. in current channel conditions, action 408. In this example the indices 1 and 4 are reported in order to indicate that option 1 and 4 are available.

The gNB then provides a reference signal configuration and a reference signal measurement configuration (in this case a CSI-RS configuration and a CSI report configuration) which may indicate a specific one of the one or more configurations indicated by the rank structure information, action 409. While the configurations as such may have been be signaled to the UE via higher layers (e.g. via RRC, such as in action 403), the specific configurations may be indicated or activated by using for instance DCI or MAC signaling to provide a dynamic update. A DCI or MAC signaling may carry the selected index as an information element and the UE may either ACK or NACK the signaling via HARQ ACK/NACK on PUCCH or on PUSCH.

The UE receives and measures CSI-RS resource(s), action 410, and provides a corresponding CSI report, action 411, that may for instance include various channel state information, such as quality indicators. For instance, the CSI report may comprise or pertain to one or more of the following indicators CQI (Channel Quality Indicator), PMI (Precoding Matrix Indicator), CRI (CSI-RS Resource Indicator), SSBRI (SS/PBCH Resource Block Indicator), LI (Layer Indicator), RI (Rank Indicator), and/or L1-RSRP.

There may then be a downlink control information, DCI, scheduling a downlink PDSCH transmission according to the CSI report, action 412, and thereafter there may then be a corresponding downlink PDSCH transmission.

Referring to FIG. 4b, a further example embodiment will now be described in connection with the signaling flow chart 400b illustrating how the approach described herein is employed for SRS and an uplink transmission.

With respect to actions 401-408, it can first be referred to the above description of FIG. 4a, since these actions are also present in the embodiment of FIG. 4b. However, different from FIG. 4a, in the embodiment illustrated by FIG. 4b, after transmitting the rank structure information, action 408, the gNB transmits a reference signal configuration to the UE, which is an SRS configuration, action 413. However, similar to the example of FIG. 4a, the reference signal configuration is determined in accordance with the particular configuration reported by the UE in action 408. The UE then transmits, to the gNB, and based on the received reference signal configuration, one or more SRS, action 414. The network can then measure the SRS(s) and determine the channel quality and decide on parameters such as TPMI, rank and/or MCS, action 415. The UE then receives, from the gNB, downlink control information scheduling the layered UL transmission according to the parameters derived from the SRS measurement, action 416. The UE can then perform a UL PUSCH transmission according to the DCI scheduling and thus the parameters derived from the SRS measurement.

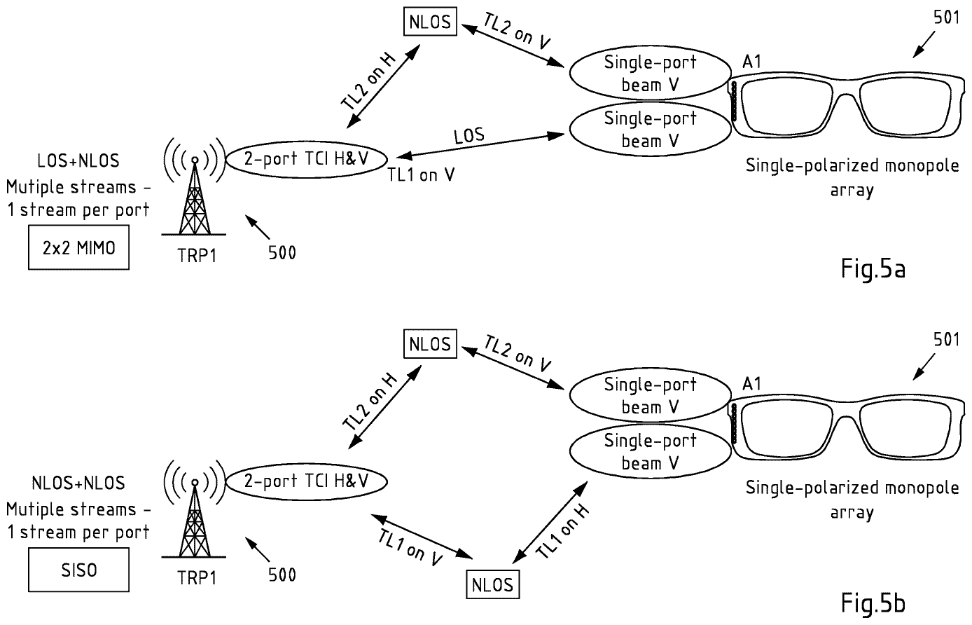

With reference to FIG. 5, it will now be described how the channel environment may affect the MIMO rank of the 2-port TCI state detected by a single-polarized array at the UE, illustrating the advantage of a dynamic indication of the supported configurations of the rank structure.

The TCI states configuration required for MIMO on the XR glasses array may dynamically change depending on the environment, as illustrated in FIG. 5. Indeed, in the scenario of FIG. 5a, the gNB 500 is configured with a single TCI state and the single TCI state may provide 2×2 MIMO for the UE 501, because the horizontal polarization of layer 2 will be received as a vertical polarization due to the non-line-of-sight, NLOS, channel. Thus, both transmission layers 1 (TL1) and 2 (TL2) can be detected by the UE 501. However, in the bottom scenario, the gNB 500 must apply a 2-TCI states-configuration to enable 2×2 MIMO at the UE (similar to the LOS scenario shown in FIG. 3c), and this will dynamically change with the channel multipath properties.

As described above, the UE may thus provide assistance to the network by means of the rank structure information e.g. in L1 (e.g. new fields in CSI report or e.g. new fields in L1-RSRP beam reporting or e.g. a new rank structure reporting) or in L2 MAC (e.g. in an existing or a new MAC CE(s)) regarding the MIMO gNB beam configuration required to support higher layer MIMO.

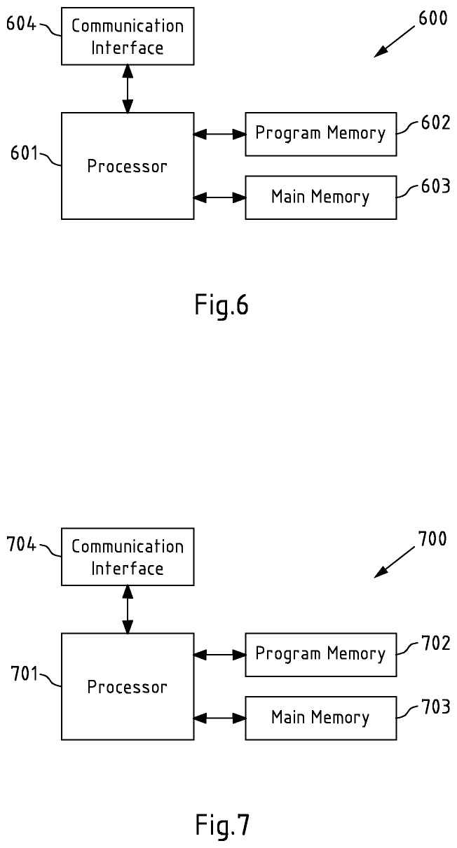

Turning now to FIG. 6, there is shown a block diagram of an exemplary embodiment of a terminal device or UE 600 according to the present disclosure. For example, terminal device 600 may be one of a smartphone, a tablet computer, a notebook computer, a smart watch, a smart band, an LPWAN device, an IoT device, an eMTC device or a vehicle or a part thereof.

Terminal device 600 comprises a processor 601. Processor 601 may represent a single processor or two or more processors, which are for instance at least partially coupled, for instance via a bus. Processor 601 executes a program code stored in program memory 602 (for instance program code causing terminal device 600 in connection with a network node or base station) to perform one or more of the embodiments of a method according to the present disclosure or parts thereof, when executed on processor 601, and interfaces with a main memory 603. Program memory 602 may also contain an operating system for processor 601. Some or all of memories 602 and 603 may also be included into processor 601.

One of or both of a main memory and a program memory of a processor (e.g. program memory 602 and main memory 603) could be fixedly connected to the processor (e.g. processor 601) or at least partially removable from the processor, for instance in the form of a memory card or stick.

A program memory (e.g. program memory 602) may for instance be a non-volatile memory. It may for instance be a FLASH memory (or a part thereof), any of a ROM, PROM, EPROM, MRAM or a FeRAM (or a part thereof) or a hard disc (or a part thereof), to name but a few examples. For example, a program memory may for instance comprise a first memory section that is fixedly installed, and a second memory section that is removable from, for instance in the form of a removable SD memory card.

A main memory (e.g. main memory 603) may for instance be a volatile memory. It may for instance be a DRAM memory, to give non-limiting example. It may for instance be used as a working memory for processor 601 when executing an operating system, an application, a program, and/or the like.

Processor 601 further controls a communication interface 604 (e.g. radio interface) configured to receive and/or transmit data and/or information. For instance, communication interface 604 may be configured to transmit and/or receive radio signals from a network node, such as a base station, in particular as described herein. It is to be understood that any computer program code based processing required for receiving and/or evaluating radio signals may be stored in an own memory of communication interface 604 and executed by an own processor of communication interface 604 and/or it may be stored for example in memory 603 and executed for example by processor 601.

Additionally, the communication interface 604 may further comprise a BLE and/or Bluetooth radio interface including a BLE transmitter, receiver or transceiver. For example, radio interface 604 may additionally or alternatively comprise a WLAN radio interface including at least a WLAN transmitter, receiver or transceiver.

The components 602 to 604 of terminal device 600 may for instance be connected with processor 601 by means of one or more serial and/or parallel busses.

It is to be understood that terminal device 600 may comprise various other components. For example, terminal device 600 may optionally comprise a user interface (e.g. a touch-sensitive display, a keyboard, a touchpad, a display, etc.).

FIG. 7 is a block diagram of an exemplary embodiment of a network node 700, such as a base station (in particular a gNB). For instance, network node 700 may be configured for scheduling and/or transmitting signals to the terminal device, as described above.

Network node 700 comprises a processor 701. Processor 701 may represent a single processor or two or more processors, which are for instance at least partially coupled, for instance via a bus. Processor 701 executes a program code stored in program memory 702 (for instance program code causing network node 700 to perform alone or together with the terminal device 600 embodiments according to the present disclosure or parts thereof), and interfaces with a main memory 703.

Program memory 702 may also comprise an operating system for processor 701. Some or all of memories 702 and 703 may also be included into processor 701.

Moreover, processor 701 controls a communication interface 704 which is for example configured to communicate according to a cellular communication system like a 2G/3G/4G/5G cellular communication system. Communication interface 704 of network node 700 may be realized by radio heads for instance and may be provided for communication between network node and the terminal device, as described above.

The components 702 to 704 of network node 700 may for instance be connected with processor 701 by means of one or more serial and/or parallel busses.

It is to be understood that terminal device 600 and network node 700 may comprise various other components.

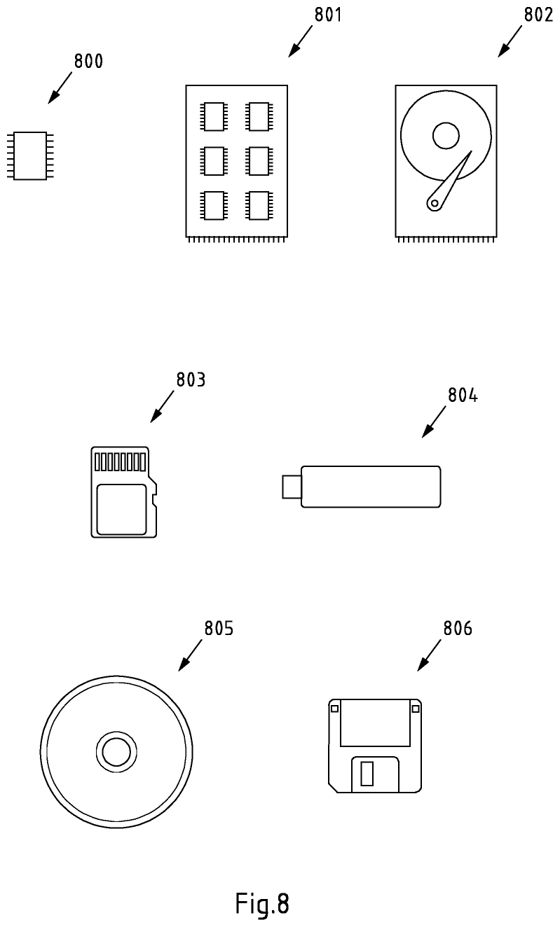

FIG. 8 is a schematic illustration of examples of tangible and non-transitory computer-readable storage media according to the present disclosure that may for instance be used to implement memory 602 of FIG. 6 or memory 702 of FIG. 7. To this end, FIG. 8 displays a flash memory 800, which may for instance be soldered or bonded to a printed circuit board, a solid-state drive 801 comprising a plurality of memory chips (e.g. Flash memory chips), a magnetic hard drive 802, a Secure Digital (SD) card 803, a Universal Serial Bus (USB) memory stick 804, an optical storage medium 805 (such as for instance a CD-ROM or DVD) and a magnetic storage medium 806.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:
(a) hardware-only circuit implementations (such as implementations in only analog and/or digital circuitry)
(b) combinations of circuits and software (and/or firmware), such as: (i) to a combination of processor(s) or (ii) to sections of processor(s)/software (including digital signal processor(s)), software, and memory(ies) that work together to cause an apparatus, such as a mobile phone, to perform various functions) and
(c) to circuits, such as a microprocessor(s) or a section of a microprocessor(s), that re-quire software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or section of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 601 and 701 of FIGS. 6 and 7, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions or steps described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICS, signal processing devices, and other devices.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The wording “A, or B, or C, or a combination thereof” or “at least one of A, B and C” may be understood to be not exhaustive and to include at least the following: (i) A, or (ii) B, or (iii) C, or (iv) A and B, or (v) A and C, or (vi) B and C, or (vii) A and B and C.

It will be understood that the embodiments disclosed herein are only exemplary, and that any feature presented for a particular exemplary embodiment may be used with any aspect of the present disclosure on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

### LIST OF ABBREVIATIONS

CE Control Element
CQI Channel Quality Information
CSI-RS Channel State Information Reference Signal
gNB 5G Node B
MAC Medium Access Control
MIMO Multiple Input Multiple Output
FR1 Frequency Range 1
FR2 Frequency Range 2
TCI Transmission Configuration Indicator
UE User Equipment
PMI Precoding Matrix Indicator
TPMI Transmit Precoding Matrix Indicator
CRI CSI-RS Resource Indicator
SSBRI SS/PBCH Resource Block Indicator
LI Layer Indicator
RI Rank Indicator
L1-RSRP Level 1 reference signal received power
SRS Sounding Reference Signal
MCS Modulation and Coding Scheme
CG Configured Grant
KPI Key Performance Indicator
PDB Packet Delay Budget

1. A terminal device comprising:
at least one processor; and
at least one memory storing instructions that, when executed by the at least one processor, cause the terminal device at least to perform:
transmitting, to a network node, rank structure information indicative of a particular configuration of one or more reference signal resources useable for channel state information, CSI, acquisition to enable a layered transmission between the network node and the terminal device having a rank value lower than or equal to a particular maximum rank value.

2. The terminal device of claim 1, wherein the particular configuration is indicative of:
a number of reference signal resources; and
a number of ports to be used for a respective reference signal resource,

3. The terminal device of claim 1, wherein the particular maximum rank value is equal to a total number of ports summed across the number of reference signal resources.

4. The terminal device of claim 1, wherein the particular configuration is determined based on one or more of:
current channel conditions as observed by the terminal device;
a position of the terminal device;
an orientation of the terminal device; and
activated and/or deactivated antenna elements of the terminal device.

5. The terminal device of claim 1 further caused to at least perform:
transmitting, to the network node, rank structure capability information indicative of one or more configurations of reference signal resources supported by the terminal device and associated with respective supported maximum rank values.

6. The terminal device of claim 5, wherein a respective configuration of the one or more configurations is indicative of:
a number of reference signal resources; and
a number of ports to be used for a respective reference signal resource.

7. The terminal device of claim 6, wherein a respective supported maximum rank value associated with the respective configuration is equal to a total number of ports summed across the number of reference signal resources.

8. The terminal device of claim 6, wherein the rank structure capability information is based on one or more of the following:
a number of antenna elements of the terminal device;
an arrangement of one or more antenna elements of the terminal device;
a polarization mode supported by one or more antenna elements of the terminal device;
a number of physical antenna ports of one or more antenna elements of the terminal device; and
a physical characteristic of one or more antenna elements of the terminal device.

9. The terminal device of claim 5, wherein the particular configuration of the rank structure information is selected from the one or more configurations of the rank structure capability information.

10. The terminal device of claim 1, wherein the layered transmission is a downlink layered transmission from the network node to the terminal device, and the one or more reference signal resources are one or more channel state information reference signal, CSI-RS, resources,
wherein the terminal device is further caused to at least perform:
receiving, from the network node, a reference signal configuration and a reference signal measurement configuration, wherein the reference signal configuration is determined in accordance with the particular configuration.

11. The terminal device of claim 1, wherein the layered transmission is an uplink layered transmission from the terminal device to the network node, and the one or more reference signal resources are one or more sounding reference signal, SRS, resources,
wherein the terminal device is further caused to at least perform:
receiving, from the network node, a reference signal configuration, wherein the reference signal configuration is determined in accordance with the particular configuration.

12. The terminal device of claim 10 further caused at least to perform:
measuring, based on the reference signal configuration and on the reference signal measurement configuration, one or more configured reference signals;
transmitting, to the network node, a measurement report on the one or more configured reference signals; and
receiving, from the network node, downlink control information scheduling the layered transmission.

13. The terminal device of claim 11 further caused at least to perform:
transmitting, to the network node, and based on the reference signal configuration, one or more configured reference signals; and
receiving, from the network node, downlink control information scheduling the layered transmission.

14. The terminal device of claim 1, wherein the particular configuration is selected from a set comprising one or more of the following configurations:
a configuration pertaining to rank 2 and defining one reference signal resource with two ports;
a configuration pertaining to rank 3 and defining one reference signal resource with three ports;
a configuration pertaining to rank 4 and defining one reference signal resource with four ports;
a configuration pertaining to rank 2 and defining one reference signal resource with two ports;
a configuration pertaining to rank 2 and defining two reference signal resources with one port each;
a configuration pertaining to rank 3 and defining two reference signal resources with one port and two ports, respectively;
a configuration pertaining to rank 3 and defining three reference signal resources with one port each;
a configuration pertaining to rank 4 and defining two reference signal resources with two ports each; and
a configuration pertaining to rank 4 and defining four reference signal resources with one port each.

15. A network node comprising:
at least one processor; and
at least one memory storing instructions that, when executed by the at least one processor, cause the network node at least to perform:
receiving, from a terminal device, rank structure information indicative of a particular configuration of one or more reference signal resources useable for channel state information, CSI, acquisition to enable a layered transmission between the network node and the terminal device having a rank value lower than or equal to a particular maximum rank value.

16-17. (canceled)

18. The network node of claim 15 further caused to at least perform:
receiving, from the terminal device, rank structure capability information indicative of one or more configurations of reference signal resources supported by the terminal device and associated with respective supported maximum rank values.

19. (canceled)

20. The network node of claim 15, wherein the layered transmission is a downlink layered transmission from the network node to the terminal device, and the one or more reference signal resources are one or more channel state information reference signal, CSI-RS, resources,
wherein the network node is further caused to at least perform:
transmitting, to the terminal device, a reference signal configuration and a reference signal measurement configuration, wherein the reference signal configuration is determined in accordance with the particular configuration.

21. The network node of claim 15, wherein the layered transmission is an uplink layered transmission from the terminal device to the network node, and the one or more reference signal resources are one or more sounding reference signal, SRS, resources,
wherein the network node is further caused to at least perform:
transmitting, to the terminal device, a reference signal configuration, wherein the reference signal configuration is determined in accordance with the particular configuration.

22. The network node of claim 20 further caused to at least perform:
transmitting, to the terminal device, based on the reference signal configuration, one or more configured reference signals;
receiving, from the terminal device, a measurement report on the one or more configured reference signals; and
transmitting, to the terminal device, downlink control information scheduling the layered transmission,
wherein the downlink control information is determined based on the measurement report.

23-24. (canceled)

25. A method, performed by a terminal device, the method comprising:
transmitting, to a network node, rank structure information indicative of a particular configuration of one or more reference signal resources useable for channel state information, CSI, acquisition to enable a layered transmission between the network node and the terminal device having a rank value lower than or equal to a particular maximum rank value.

26-28. (canceled)
